(19) United States
(12) Patent Application Publication
(10) Pub. No.: US 2024/0142042 A1
(43) Pub. Date: May 2, 2024

(54) EXHAUST INSULATION SYSTEM

(71) Applicant: SAPREX, LLC, Gastonia, NC (US)

(72) Inventor: Robert Jacque GOULET, Gastonia, NC (US)

(73) Assignee: NELSON GLOBAL PRODUCTS, INC., STOUGHTON, WI (US)

(21) Appl. No.: 17/769,643

(22) PCT Filed: Oct. 15, 2020
(86) PCT No.: PCT/US2020/055810

§ 371 Date: Apr. 15, 2022

Related U.S. Application Data
(60) Provisional application No. 62/915,473, filed on Oct. 15, 2019.

(51) Int. Cl. F16L 59/18; F16L 59/153

(52) U.S. Cl. CPC F16L 59/184; F16L 59/153

(57) ABSTRACT

Embodiments of the invention provide an exhaust insulation system structured for effectively insulating an exhaust system of an automobile. In some embodiments, the exhaust insulation system comprises a pipe joint insulation component structured for insulating a pipe joint of an exhaust system. In some embodiments, the exhaust insulation system comprises a hanger pipe insulation component structured for insulating an exhaust system pipe at a portion of the pipe proximate a hanger pipe assembled onto the pipe. In some embodiments, the exhaust insulation system comprises a bellows insulation component structured for insulating one or more bellows of the exhaust system.

### CROSS-REFERENCE TO PRIORITY APPLICATION

This application claims priority to and the benefit of U.S. Provisional Patent Application No. 62/915,473 filed Oct. 15, 2019, titled “Exhaust Insulation System,” which is hereby incorporated by reference in its entirety.

### FIELD OF THE INVENTION

Embodiments disclosed herein relate to an insulation system for industrial, automotive and recreational vehicle applications that typically involve transport of fluids through pipes and ducts. Specifically, embodiments of the invention relate to customizable insulation components for various parts of exhaust systems, and that of automotive exhaust systems in particular.

### BACKGROUND

Pipes in automotive, transportation and industrial sectors are typically unique to a particular application. Moreover, these pipes (e.g., various pipes of an automobile exhaust system) are typically shaped, sized and dimensioned differently, may comprise varying structures and materials, and may be subject to differing operating conditions. Typically conventional insulation is uniform throughout the system to minimize application complexity, yet the thermal loss exhibited throughout the system is non-uniform. As such, conventional insulation not structured to cater to the varying pipe geometry and insulation requirements. The installation of conventional insulations systems is typically required to be performed at the time of the manufacture of the components. Conventional insulations are typically not structured for installation at other times such as after assembly, during use, etc. Moreover, in the case of deterioration of the insulation due to wear during use, conventional insulations cannot be easily replaced or supplemented, without complete disassembly of the pipe components and/or without discarding the pipe with the insulation and replacing it in the case of permanent type conventional insulations.

Accordingly, there is a need for a customizable insulation system that is structured to insulate the various pipes (e.g., various pipes of an automobile exhaust system) in a manner specific to their individual structure, size, shape, material and operating condition, and which is structured for ease of installation or assembly at any suitable time.

### BRIEF SUMMARY

Embodiments of the present invention addressed the above needs and/or achieve other advantages by providing a comprehensive exhaust insulation system that is structured for specific geometric and insulation requirements of the various pipe components. Moreover, embodiments of the exhaust insulation system of the present invention are structured for easy installation/assembly at any suitable time, such as after assembly, during use, during manufacture etc., without requiring disassembly of the exhaust insulation system. Moreover, embodiments of the exhaust insulation system of the present invention are structured for ease of replacement and customizable layering (e.g., for the purposes of supplementing insulation for pipe components requiring greater insulation).

Embodiments of the invention provide an exhaust insulation system structured for effectively insulating an exhaust system of an automobile. In some embodiments, the exhaust insulation system comprises a pipe joint insulation component structured for insulating a pipe joint of an exhaust system. In some embodiments, the exhaust insulation system comprises a hanger pipe insulation component structured for insulating an exhaust system pipe at a portion of the pipe proximate a hanger pipe assembled onto the pipe. In some embodiments, the exhaust insulation system comprises a bellows insulation component structured for insulating one or more bellows of the exhaust system.

In some embodiments, and in combination with the above embodiment, the pipe joint insulation component comprises a first body structure comprising an insulation body portion, wherein the insulation body portion is structured for insulating a pipe joint of an exhaust system, wherein the first body structure comprises a cavity structured for receiving the pipe joint therethrough, wherein the insulation body portion comprises one or more insulation layers.

In some embodiments, and in combination with any of the above embodiments, the first body structure comprises a cutout void; wherein the cutout void comprises a first width lesser than a diameter of the pipe joint.

In some embodiments, and in combination with any of the above embodiments, the cutout void is structured to receive a pipe joint therethrough in a radial direction substantially perpendicular to an axis of the first body structure.

In some embodiments, and in combination with any of the above embodiments, the pipe joint insulation component comprises one or more securing members structured for securing the first body structure around the pipe joint.

In some embodiments, and in combination with any of the above embodiments, the one or more securing members comprise a band clamp and/or a spring-loaded clamp.

In some embodiments, and in combination with any of the above embodiments, the first body structure is structured to be coupled with a coupling member of the pipe joint.

In some embodiments, and in combination with any of the above embodiments, the first body structure comprises one or more securing members at an inner surface.

In some embodiments, and in combination with any of the above embodiments, the one or more securing members are structured to couple the first body structure with a coupling member of the pipe joint.

In some embodiments, and in combination with any of the above embodiments, the pipe joint insulation component further comprises a second body structure, wherein the second body structure is configured to be coupled with the first body structure.

In some embodiments, and in combination with the above embodiment, the hanger pipe insulation component comprises a first insulation body portion structured for at least partially enclosing and insulating an exhaust system pipe at a portion of the pipe proximate a hanger pipe assembled onto the pipe, wherein the first insulation body comprises one or more insulation layers.

In some embodiments, and in combination with any of the above embodiments, wherein the first insulation body portion is structured to enclose the pipe such that linear motion of the hanger pipe in a direction substantially parallel to an axis of the pipe is not blocked.

In some embodiments, and in combination with any of the above embodiments, the first insulation body portion is flexible.

In some embodiments, and in combination with any of the above embodiments, the pipe joint insulation component comprises one or more securing members structured for securing the first body structure around the pipe joint.

In some embodiments, and in combination with any of the above embodiments, the one or more securing members comprise a band clamp and/or a spring-loaded clamp.

In some embodiments, and in combination with any of the above embodiments, the one or more insulation layers comprises a knitted layer and/or a woven layer.

In some embodiments, and in combination with any of the above embodiments, the hanger pipe insulation component further comprises a second insulation body portion, wherein the insulation body portion is configured to be coupled with the first insulation body portion.

In some embodiments, and in combination with the above embodiment, the bellows insulation component comprises an insulation body portion structured for insulating one or more bellows of an exhaust system, wherein the insulation body is structured for at least partially enclosing and insulating the one or more bellows, wherein the insulation body comprises one or more insulation layers.

In some embodiments, and in combination with any of the above embodiments, the insulation body portion comprises a cavity structured to receive the one or more bellows therethrough, wherein the insulation body is structured insulating the one or more bellows without blocking the flexibility of the one or more bellows.

In some embodiments, and in combination with any of the above embodiments, the insulation body portion is flexible.

In some embodiments, and in combination with any of the above embodiments, the ends of the insulation body portion are secured to adjacent ends of the one or more bellows.

In some embodiments, and in combination with any of the above embodiments, the one or more insulation layers comprises a knitted layer and/or a woven layer.

### BRIEF DESCRIPTION OF THE DRAWINGS

The present embodiments are further described in the detailed description which follows in reference to the noted drawings by way of non-limiting examples of the present embodiments on which like reference numerals represent parts throughout the several views of the drawings.

The foregoing and other features of the invention, and the manner in which the same are accomplished, will become more readily apparent upon consideration of the following detail description of the invention taken in conjunction with the accompanying drawings, which illustrate non-limiting examples of embodiments of the present invention and which are not necessarily drawn to scale In the drawings:

FIG. 1 is a perspective cutaway view 10 illustrating an exhaust insulation system, in accordance with one embodiment of the invention.

FIG. 2a is a cutaway view 20A illustrating a pipe joint, in accordance with one embodiment of the invention.

FIG. 2b is a perspective view 20B illustrating a coupling member of FIG. 2a, in accordance with one embodiment of the invention.

FIG. 3a is a perspective view 30A illustrating a pipe joint insulation component, in accordance with one embodiment of the invention.

FIG. 3b illustrates sectional views 30B associated with the pipe joint insulation component of FIG. 3a.

FIG. 3c is a perspective view 30C illustrating the pipe joint insulation component of FIG. 3a.

FIG. 3d is a perspective view 30D illustrating an assembly of the pipe joint insulation component of FIG. 3a.

FIG. 4a is a perspective view 40A illustrating a pipe joint insulation component, in accordance with one embodiment of the invention.

FIG. 4b is a perspective view 40B illustrating the pipe joint insulation component of FIG. 4a.

FIG. 4c is a perspective view 40C illustrating an assembly of the pipe joint insulation component of FIG. 4a.

FIG. 5 is a perspective view 50 illustrating a pipe having a hanger, in accordance with one embodiment of the invention.

FIG. 6 is a perspective view 60 illustrating a hanger pipe insulation component, in accordance with one embodiment of the invention.

FIG. 7 is a perspective view 70 illustrating a hanger pipe insulation component, in accordance with one embodiment of the invention.

FIG. 8 is a perspective view 80 illustrating a preformed pipe insulation component, in accordance with one embodiment of the invention.

FIG. 9 is a perspective view 90 illustrating a bellows insulation component, in accordance with one embodiment of the invention.

FIG. 10 is a perspective view 100 illustrating a bellows insulation component, in accordance with one embodiment of the invention.

### DETAILED DESCRIPTION OF EMBODIMENTS OF THE INVENTION

The following detailed description refers to the accompanying drawings, which illustrate specific embodiments. Other embodiments having different structures and operation do not depart from the scope of the present disclosure.

Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first. Typically, like reference numerals refer to the same or similar parts.

A “pipe” as used herein may refer to a tube, a duct, a pipeline, a cylinder, a channel, and/or a conduit. In some embodiments, “pipe” may refer to a component that requires insulation. In some embodiments, “pipe” may refer to a component that is structured for conveying fluid. In some embodiments, a pipe, as used herein, may comprise a hollow, a cavity, or an annular space. A “pipe joint” as used herein may refer to an assembly of at least two pipes, typically, end-to-end, e.g., pipes that are attached/assembled to each other coaxially.

The embodiments of the insulation system of the present invention are described with respect to an exhaust system, and an automobile exhaust system (e.g., car exhaust, truck exhaust, etc.) in particular. That said, it is understood that the insulation system of the present invention can also be employed in various other automotive, residential or industrial applications, or any other applications/systems which require insulation.

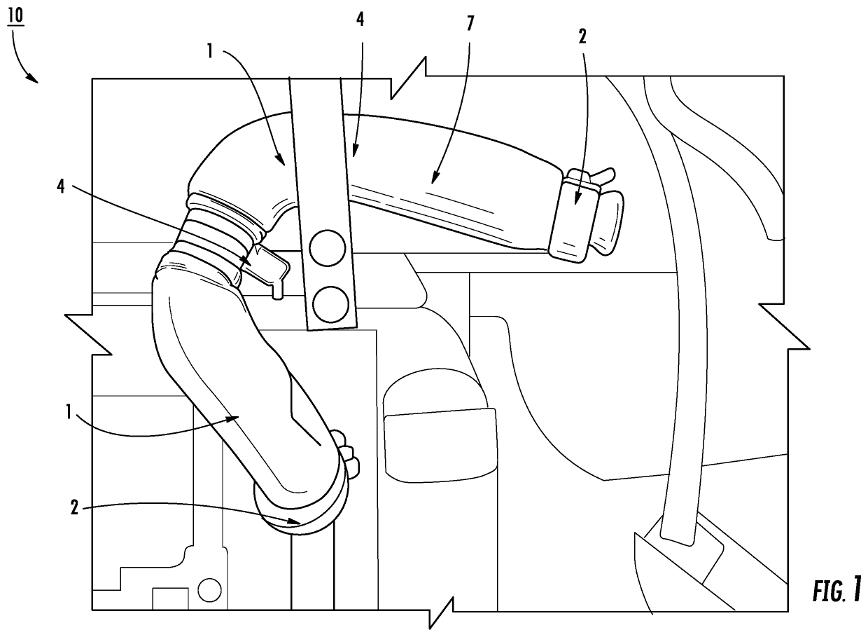

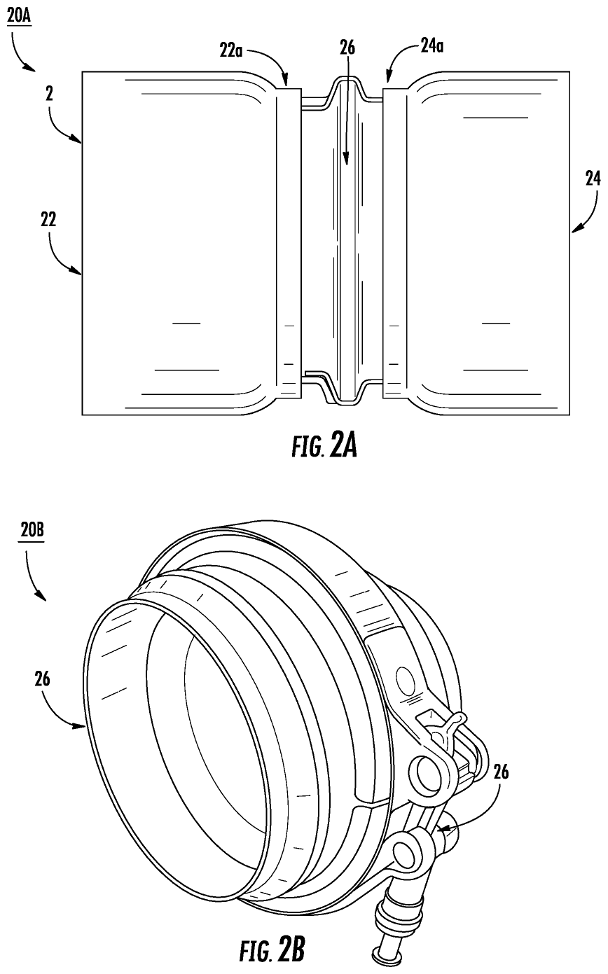

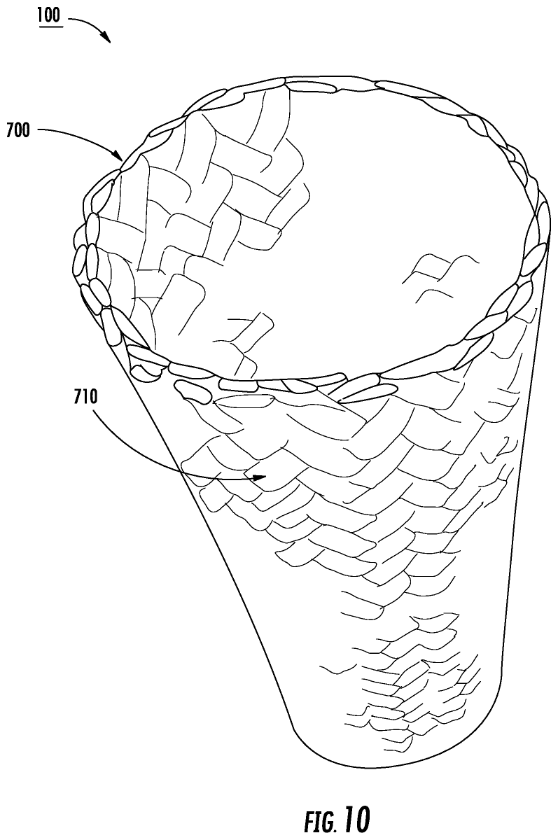

Referring to the drawings, FIG. 1 illustrates a perspective cutaway view 10 of an illustrative non-limiting example of an exhaust system, in accordance with one embodiment of the invention. In some embodiments, the exhaust system of FIG. 1 is associated with a truck. The exhaust system typically comprises a plurality of pipe components. As illustrated by FIG. 1, these pipe components comprise one or more pipes 1, one or more pipe joints 2 at adjacent pipes, pipes with hanger clamps 4, one or more bellows 7, etc. As discussed, the one or more pipes 1 may refer to a tube, a duct, a pipeline, a cylinder, a channel, and/or a conduit. The one or more pipe joints 2 typically comprise an end-to-end assembly of adjacent pipes (e.g., as illustrated by FIG. 2a). Typically, at least some of the pipes may be required to be attached to the frame (e.g., frame of the automobile such as a truck). Here, hanger clamps 4 are provided for attaching the pipes to the frame (e.g., as illustrated by FIG. 5). The one or more bellows 7 may comprise flexible pipes structured for isolating vibrations from an associated engine exhaust system (e.g., as illustrated by FIG. 9).

Typically, in conventional systems, the coupling members and proximate pipe portions of the one or more pipe joints 2 are not insulated, e.g., due to lack of access to the component once assembled, due to the need for assembling and disassembling the component repeatedly, etc. In conventional systems, the pipes having the hanger clamps 4 are left uninsulated along regions adjacent to the hanger clamps 4, (i) in order to accommodate the hanger clamps 4, and (ii) to allow for movement of the hanger clamps 4 along and over the pipe, e.g., during assembly to mitigate and compensate for production variations. Depending on the type of application, up to 6 inches or more than 6 inches of pipe adjacent the hanger clamp 4, may be left uninsulated for the foregoing reasons. Moreover, the one or more bellows 7 are required to be flexible for the purposes of mitigating vibration from the engine. However, in conventional systems, the one or more bellows 7 are not insulated because conventional insulation may render the one or more bellows 7 rigid and inflexible.

As such, in conventional systems only certain portions of the pipes 1 are able to be insulated. However, this has the significant drawback of not being able to insulate large portions of the exhaust system, such as but not limited to, one or more pipe joints, pipes having the hanger clamps, one or more bellows, etc. This lack of insulation on large swathes of the exhaust system, may result in undesirable heat transfer in the areas without insulation, adversely affect the efficiency and performance of the exhaust system, and may even diminish the performance and benefits of even portions that are insulated.

The exhaust insulation system of the present invention addresses the above challenges and alleviates the foregoing deficiencies, by providing comprehensive and customized insulation for the various components of the exhaust system (e.g., components such as but not limited to, one or more pipe joints, pipes having the hanger clamps, one or more bellows, etc.), without impeding their functional or operating requirements, as will be described in detail below with respect to FIGS. 2a-10.

The features of a pipe joint insulation component of the present invention will now be described with respect to FIGS. 2a-4c. The pipe joint insulation component is structured for insulating pipe joints/junctions, pipe connections and/or associated coupling member (e.g., clamps). FIG. 2a illustrates a cutaway view 20A illustrating a pipe joint, in accordance with one embodiment of the invention. Specifically, FIG. 2a illustrates a first pipe 22 having an end 22a and a second pipe 24 having an end 24a. In some embodiments, the end 22a of the first pipe 22 and the end 24a of second pipe 24 comprise marman flanges. The first pipe 22 and the second pipe 24 are arranged such that the respective ends 22a and 24a are proximate or facing each other, as illustrated. The first pipe 22 is coupled to the second pipe 24 via a coupling member 26. Coupling as used herein may refer to or connecting, fastening or otherwise joining, either removably or permanently. In some embodiments, the coupling member 26 removably couples the first pipe 22 and the second pipe 24. Typically, as illustrated, one end of the coupling member 26 is coupled to the first pipe 22 proximate the end 22a and the opposite end of the coupling member 26 is coupled to the second pipe 24 proximate the end 24a. In this regard, in some embodiments, one end of the coupling member 26 is coupled to the marman flange of the end 22a and the opposite end of the coupling member 26 is coupled to marman flange of the end 24a.

FIG. 2b illustrates a perspective view 20B of the coupling member 26 of FIG. 2a, in accordance with one embodiment of the invention. Typically, the coupling member 26 may comprise a clamp, a component(s) structured for press fitting/clearance fitting with the pipe 22 and/or pipe 24, a brace, a pipe joint, etc. In some embodiments, the coupling member 26 may be integral with the pipe 22 and/or pipe 24. In some embodiments, particularly in the instances where the coupling member 26 is a clamp, the coupling member may comprise a locking mechanism 28. Here, the locking mechanism 28 is structured for securing, holding, fixing, and/or tightening (e.g., removably) the coupling member 26 at the pipe joint. In some embodiments, the coupling member 26 is a “V-clamp” or a “V-Band” clamp, as illustrated by FIG. 2b. In some embodiments, the locking mechanism 28 comprises a latch, a “T-bolt”, a spring-loaded lock, a snap lock, etc.

As discussed previously, in conventional systems, the coupling members and proximate pipe portions of the one or more pipe joints 2 are not insulated, e.g., due to lack of access to the component once assembled, due to the need for assembling and disassembling the component repeatedly, etc. Moreover, conventional insulation, even if it were capable of insulating pipe joints, may impede access to the coupling member 26 and its locking mechanism 28 in particular, and/or may prevent/impede disassembly or assembly. The pipe joint insulation component (200, 300) described below is structured for effectively insulating pipe joints and coupling members in particular, while allowing for access to the coupling member 26 and its locking mechanism 28, without impeding assembly and disassembly of the joint. Moreover, the pipe joint insulation component (200, 300) is structured to be assembled at the pipe joint at any suitable stage, e.g., after assembly of the exhaust system, during use, during manufacture, etc., without requiring disassembly of the exhaust system. Moreover, the pipe joint insulation component (200, 300) can be easily removed (without requiring disassembly of the exhaust system), and is structured for customization based on the operating requirements.

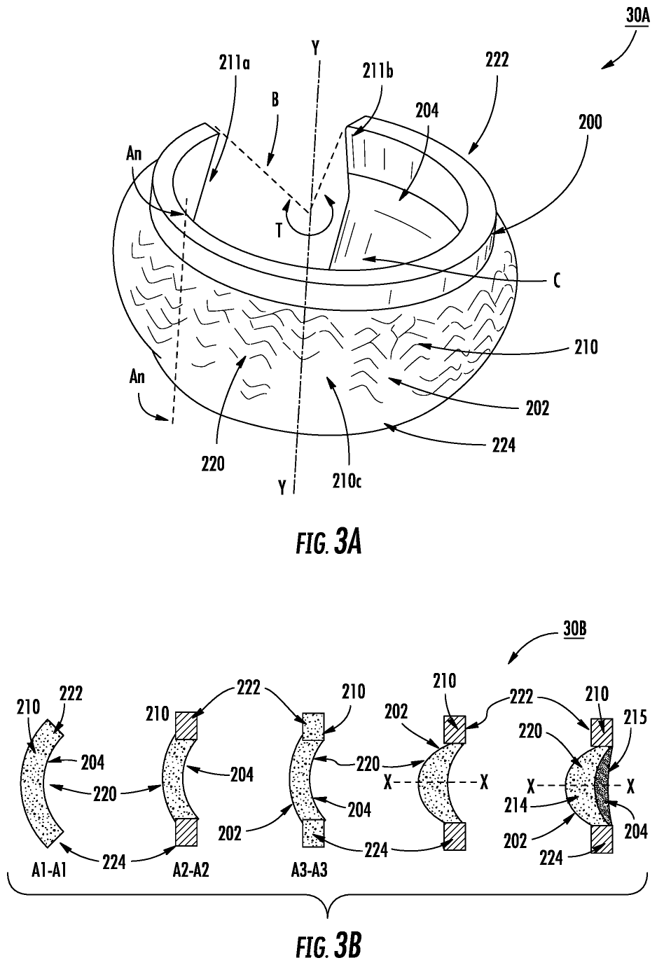

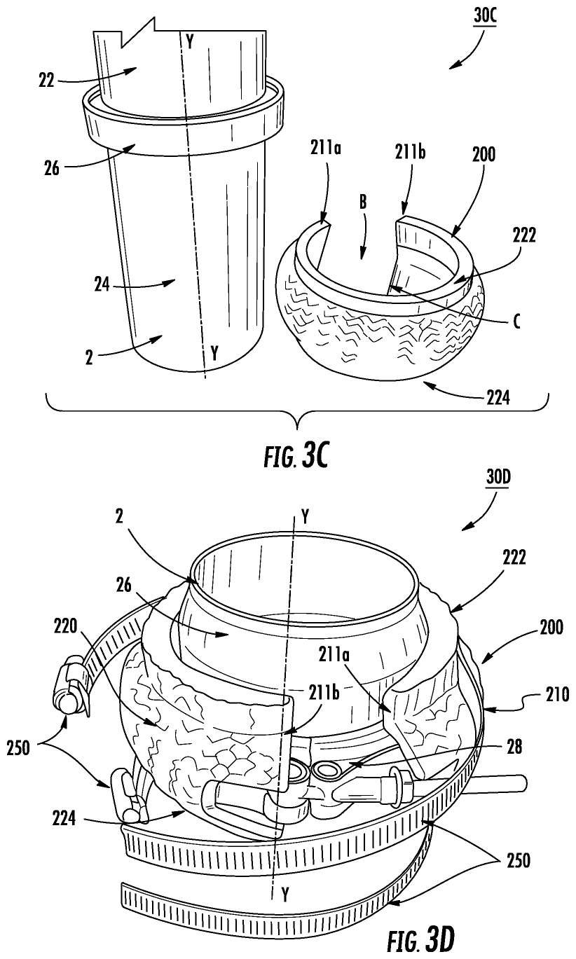

FIGS. 3a-3d illustrate a pipe joint insulation component 200, in accordance with some embodiments of the invention. The pipe joint insulation component 200 is typically structured to be assembled with the pipe joint after the assembly of the pipe joint and the exhaust system, in some embodiments. FIG. 3a provides a perspective view 30A of the pipe joint insulation component 200, in accordance with some embodiments of the invention. The pipe joint insulation component 200 comprises a body structure 210. The body structure 210 typically comprises an outer surface 202 and an opposite inner surface 204. Typically, the body structure 210 is structured to be positioned around or at the outer surface of the pipe joint, and specifically the coupling member 26, with the inner surface 204 being positioned facing and adjacent to the pipe joint (as illustrated by FIG. 3d). The body structure 210 comprises an insulation body portion 220 or insulation sleeve 220. The body structure 210 may also comprise a first lateral portion 222 at one lateral end of the insulation body portion 220 and/or an opposite second lateral portion 224 at the opposite lateral end of the insulation body portion 220, as illustrated by FIG. 3a. The lateral portions (222, 224) may be integral with the insulation body portion 220 or they may be separate components coupled with the insulation body portion 220. In some embodiments, the insulation body portion 220 comprises one or more layers of insulation material, whose numbers and arrangement are infinitely customizable based on the operating requirements of the pipe joint. In some embodiments, the lateral portions (222, 224) are structured for providing structural support to the body structure 210, and/or are structured to allow the body structure 210/pipe joint insulation component 200 to withstand hoop stresses, loads, vibrations and other operating conditions. In some embodiments, the lateral portions (222, 224) are structured for providing insulation to the pipe joint in a manner similar to the insulation body portion 220. The lateral portions (222, 224) may be made from the same material(s) or different material(s) from that of the insulation body portion 220.

In some embodiments, the insulation body portion 220 may aid in increasing, decreasing or otherwise regulating the temperature of the fluid within the pipe joint so that the fluid is emitted at a desired temperature. In some embodiments, the insulating sleeve made of one or more layers of composite materials, resins, polymers, fabrics, textiles, foam, and the like. These composite materials, resins, polymers, fabrics, etc. may be woven, knitted, braided, interlaced, non-woven, etc. In some embodiments, the one or more layers of the insulation body portion 220 may comprise structural fibers, resin fibers and/or elastic fibers, wherein: structural fibers comprise glass, carbon, polymer, ceramic, metallic, mineral and/or natural fibers; and resin fibers comprise polyethylene terephthalate (PET), polyamide (PA), polyphenylene sulfide (PPS), polyphenylene oxide ether (PPE), polyethylenimine (PEI), polyether ether ketone (PEEK), fluoric polymers such as polytetrafluoroethylene (PTFE), ethylene-tetrafluoroethylene (ETFE), polyvinylidenefluoride (PVDF), and/or ethylene-tetrafluoroethylene (ETFE) based fibers (which may be woven, knitted, braided, interlaced, etc.). In some embodiments, the one or more layers of the insulation body portion 220 may also comprise one or more liquid polymer matrix solutions configured to be applied to the one or more layers (e.g., after assembly of the pipe joint insulation component 200 with the pipe joint), and then optionally cured (e.g., thermally cured at a predetermined temperature). In some embodiments, the one or more liquid polymer matrix solutions comprise a dispersion of ground thermoplastic polymer in an organic or non-organic solvent.

In some embodiments, the lateral portions (222, 224) may be made out of same or different materials, such as suitable grades of stainless steel, carbon steels, suitable metals like aluminum, brass, copper, tin, nickel, titanium, alloys, plastics, composites, natural or synthetic materials, polymers, and/or the like. One or both of the lateral portions (222, 224) may be made from the same material(s) at the insulation body portion 220 (as illustrated by sections A1-A1 and A3-A3 of FIG. 3b), or different material(s) from that of the insulation body portion 220 (as illustrated by sections A2-A2, A4-A4, and A5-A5 of FIG. 3b).

As illustrated by FIG. 3a, the body structure 210 defines an axis Y-Y. The pipe body structure 210, and the insulation body portion 220 and the lateral portions (222, 224) in particular, typically extend at least partially radially around and axially along the axis Y-Y. The body structure 210 comprises a cavity “C” (e.g., extending along the axis Y-Y) which is structured to receive the pipe joint therein. Moreover, the body structure 210 comprises a cutout “B” or void “B”. In other words, the body structure 210 comprises a first edge 211a (e.g., extending generally in a direction parallel to the axis Y-Y) and an opposite second edge 211b (e.g., extending generally in a direction parallel to the axis Y-Y), forming the cutout/void B therebetween. In this regard, the body structure 210 may comprise a generally C-shape or a generally arc shape with the edges (211a, 211b) forming the ends of the C-shape or arc. The body structure 210 typically subtends an angle T at the axis Y-Y from the edge 211a to the edge 211b, as shown. In some embodiments, the angle T may be in range from about 250 degrees to 320 degrees, 220 degrees to 350 degrees, 270 degrees to 340 degrees, 300 degrees to 350 degrees, 290 degrees to 355 degrees, 330 degrees to 350 degrees and/or in between, outside or overlapping these ranges. In some embodiments, the angle T is structured such that the width of the cutout/void B, e.g., the perpendicular distance between the edges 211a and 211b, is lesser than a maximum diameter of the pipes (22, 24) and/or a maximum diameter of the coupling member 26 (in the resting position).

Here, the body structure 210 is structured for allowing assembly with the assembled pipe joint (without requiring disassembly of the pipe joint). A hinge portion 210c (e.g., a portion diametrically opposite the cutout/void B) is structured to act as a hinge (e.g., a natural hinge), allowing the edges 211a and 211b to diverge from each other (increasing the distance therebetween) to receive the pipe joint therethrough in a radial direction perpendicular to the axis Y-Y in an expanded position. Once the pipe joint is received within the cavity C, the hinge portion 210c is structured to allow the body structure 210, and the edges 211a and 211b in particular, to spring back into it original/resting position (thereby holding the pipe joint in place within the cavity C). That said, it is also envisaged that the pipe joint may be inserted into the cavity C along the axial direction Y-Y, e.g., in the instances where the body structure 210 is assembled with the pipe joint, prior to the assembly of the pipe joint with the rest of the exhaust system.

Moreover, the body structure 210 may comprise a suitable cross-section An-An. The cross-section may be concave, convex, curvilinear, planar, polygonal, curved, and/or a combination of the foregoing, with constant and/or variable thicknesses. In some embodiments, the body structure 210 comprises a substantially C-shaped cross section. FIG. 3b illustrates example cross sections A1-A1 to A5-A5 for the cross-section An-An. In particular, cross sections A1-A1 to A3-A3 illustrate the body structure 210 having a constant thickness, while cross sections A4-A4 to A5-A5 illustrate the body structure 210 having a variable thickness (e.g., with a maximum thickness at a central portion X-X). Moreover, cross section A1-A1 illustrates that lateral portions (222, 224) having the same curvature as the insulation body portion 220, while the cross sections A2-A2 to A5-A5 illustrate the lateral portions (222, 224) having a substantially rectangular cross section. Furthermore, cross section A5-A5 illustrates the insulation body portion 220 having a plurality of insulation layers (214, 215) that may be releasably or permanently affixed to each other.

FIG. 3c illustrates the pipe joint insulation component 200 described above and the pipe joint 2. The pipe joint 2 may also define an axis Y-Y. Here, it is noted that in its resting state, the width of the cutout/void B, e.g., the perpendicular distance between the edges 211a and 211b, is lesser than a maximum diameter of the pipes (22, 24) and/or a maximum diameter of the coupling member 26, as shown in FIGS. 3c-3d. For assembly with the pipe joint 2, the edges 211a and 211b are diverged from each other to attain an expanded position, via the hinge portion 210c, as described previously. The pipe joint 2 (and the coupling member 26 in particular) is then inserted into the cavity C through the diverged cutout/void B, in a substantially radial direction (perpendicular to the axis Y-Y). Once the pipe joint (and the coupling member 26 in particular) is received within the cavity C, the body structure 210, and the edges 211a and 211b in particular, to spring back into the original/resting position, thereby holding the pipe joint 2 (and the coupling member 26 in particular) in place within the cavity C (by exerting a radial compressive force onto the pipe joint 2), as illustrated by the body structure 210—pipe joint 2 assembly of FIG. 3d. That said, it is also envisaged that the pipe joint 2 may be inserted into the cavity C along the axial direction Y-Y, e.g., in the instances where the body structure 210 is assembled with the pipe joint, prior to the assembly of the pipe joint with the rest of the exhaust system. As illustrated, the pipe joint insulation component 200 of the present invention is structure to insulate the pipe joint 2 (and the coupling member 26 in particular) while still allowing access to the locking mechanism 28 and the coupling member 26. In some embodiments, the body structure 210 is oriented such that the locking mechanism 28 is positioned within the cutout/void B.

As illustrated by FIG. 3d, the pipe joint insulation component 200 may further comprise one or more securing members 250, which may be looped over the body structure 210 and tightened/secured to hold the body structure 210 in place around the joint 2. The securing member 250 may be any device, tool, or fastener configured to hold or secure the body structure 210—pipe joint 2 assembly together, either by mechanical, magnetic, and/or chemical means. In some embodiments the securing member 250 is a band clamp 250, which is configured to hold, secure, fasten, or lock the body structure 210—pipe joint 2 assembly together, either removably or permanently. Here, the band clamp 250 may comprise an elongate body and a clamp member at one end of the elongate body which is configured to secure the ends of the elongate body together, at a desired tension, such that the elongate member forms a loop. As such, the clamp member may comprise hose clamps, V-Clamps, buckles, locking ties, loops, screw clips, worm drive clips, center punch clamps, spring clamps, wire clamps, ear clamps, strapping seals, cable ties, marman clamps, clasps, band clips, a combination of portions of the preceding non-limiting examples, or any other suitable clamping devices known in the art. In some embodiments, the securing member 250 is configured to secure the body structure 210 around the pipe joint 2 together, such that a desired compression (for example, radial and circumferential compression forces) may be applied onto the body structure 210 and/or the pipe joint 2 by changing the circumference/dimensions of the loop formed. The securing member 250 may be made from any suitable material, such as but not limited to, metals, alloys, composites, plastics, etc.

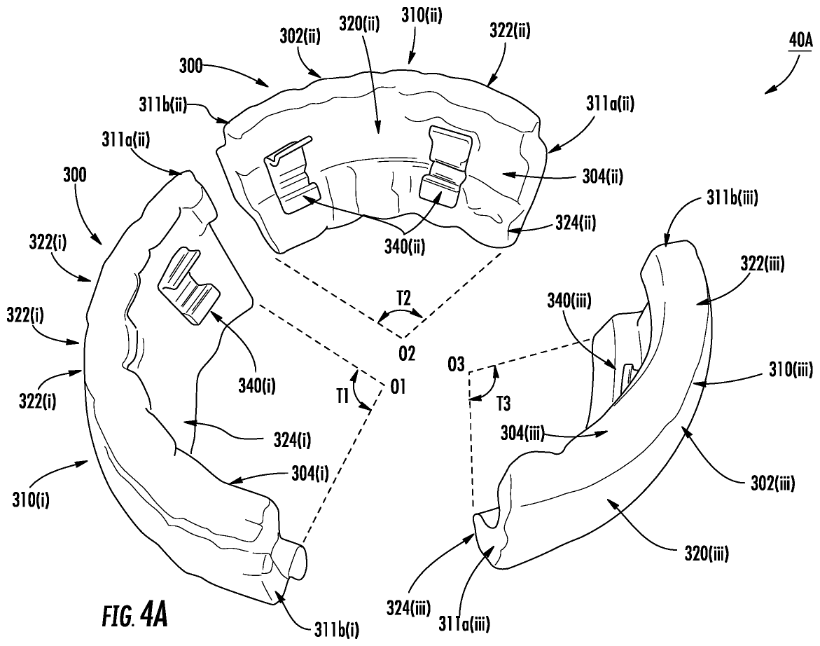

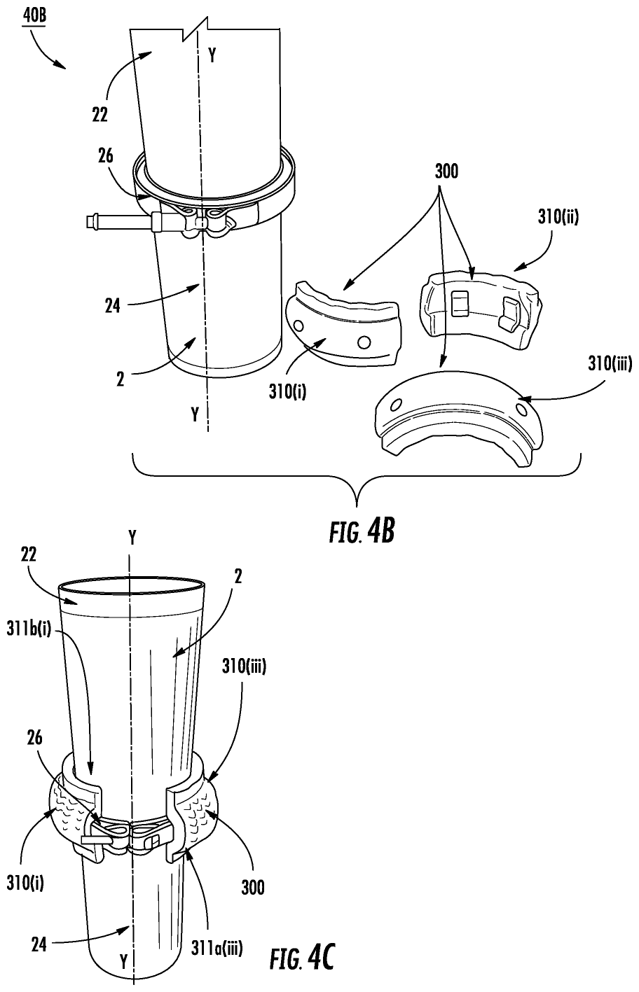

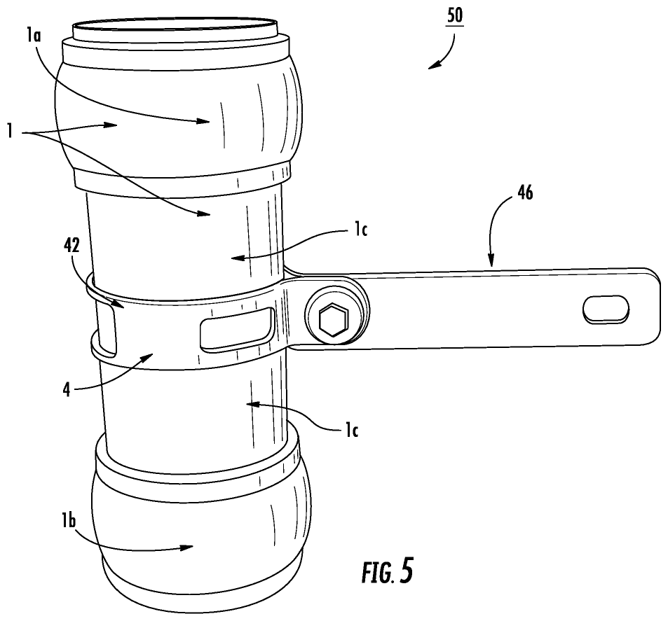

FIGS. 4a-4c illustrate a pipe joint insulation component 300, in accordance with yet other embodiments of the invention. The pipe joint insulation component 300 is typically structured to be assembled with the pipe joint before or after the assembly of the pipe joint and the exhaust system, in some embodiments. FIG. 4a provides a perspective view 40A of the pipe joint insulation component 300, in accordance with some embodiments of the invention. The joint insulation component 300 is substantially similar to the pipe joint insulation component 200 described previously, except that the pipe joint insulation component 300 comprises a plurality of body structures 310(i)-310(iii). The plurality of body structures 310(i)-310(iii) are structured to be assembled together to form the pipe joint insulation component 300. Although illustrated as three body structures 310(i)-310(iii), it is understood that more (310(i)-310(n, n>3)) or fewer body structures (310(i)-310(ii)) may be utilized in some embodiments. As such, it is understood that the element “(iii)” with respect to FIGS. 4a-4c may refer to the n^{th} body structure, with “n” being the number of body structures (e.g., “n” may be greater than or equal to 2).

Each of the plurality of body structures 310(i)-310(iii) may be substantially similar to the body structure 210 of the pipe joint insulation component 200 described previously. As such, each of the plurality of body structures 310(i)-310(iii) may comprise an outer surface 302(i)-302(iii) and an opposite inner surface 304(i)-304(iii), respectively. Typically, the plurality of body structures 310(i)-310(iii) are structured to be positioned around or at the outer surface of the pipe joint 2, and specifically the coupling member 26, with the inner surfaces 304(i)-304(iii) being positioned facing and adjacent to the pipe joint (as illustrated by FIG. 4c). Each of the plurality of body structures 310(i)-310(iii) comprise an insulation body portion 320(i)-320(iii) or insulation sleeve 320(i)-320(iii), respectively, whose structure and functions are substantially similar to the insulation body portion 220 described above. Each of the plurality of body structures 310(i)-310(iii) may also comprise a first lateral portion 322(i)-322(iii) at one lateral end of the insulation body portion 320(i)-320(iii) and/or an opposite second lateral portion 324(i)-324(iii) at the opposite lateral end of the insulation body portion 320(i)-320(iii), as illustrated by FIG. 4a. The lateral portions (322(i)-322(iii), 324(i)-324(iii)) may be substantially similar to the lateral portions (222, 224) described above.

In some embodiments, the insulation body portion 320(i)-320(iii) comprises one or more layers of insulation material, whose numbers and arrangement are infinitely customizable based on the operating requirements of the pipe joint. As discussed previously, in some embodiments, the insulation body portion 320(i)-320(iii) may aid in increasing, decreasing or otherwise regulating the temperature of the fluid within the pipe joint so that the fluid is emitted at a desired temperature. In some embodiments, the insulating sleeve made of one or more layers of any of the materials previously described with respect to the insulation body portion 220 of FIGS. 3a-3d. The lateral portions (322(i)-322(iii), 324(i)-324(iii)) may be made from the same material(s) or different material(s) from that of the insulation body portion 320(i)-320(iii), as previously described with respect to lateral portions (222, 224). Moreover, the plurality of body structures 310(i)-310(iii) may comprise any of the cross sections A1-A1 to A5-A5, or any suitable combination of these cross sections, described previously with respect to FIG. 3b.

As illustrated by FIG. 4a, each the plurality of body structures 310(i)-310(iii) defines an arc center O1-O3, respectively. Each of the plurality of body structures 310(i)-310(iii) comprises a first edge 311a(i)-311a(iii) and an opposite second edge 311b(i)-311b(iii), respectively, as illustrated by FIG. 4a. Each of the first edges 311a(i)-311a(iii) may further comprise a coupling element structured for coupling with an adjacent and second edge 311b(i)-311b(iii) of another body element having a complementary coupling element.

The plurality of body structures 310(i)-310(iii) may comprise a generally C-shape or a generally arc shape with the edges (311a(i)-311a(iii), 311b(i)-311b(iii)) forming the ends of the C-shape or arc, respectively. Each of the plurality of body structures 310(i)-310(iii) typically subtend an angle T1-T3 at the respective arc center O1-O3, from the edge 311a(i)-311a(iii) to the edge 311b(i)-311b(iii), as shown. In some embodiments, the angles T1-T3 may be in range from about 80 degrees to 106 degrees, 70 degrees to 119 degrees, 90 degrees to 115 degrees, 100 degrees to 119 degrees, 95 degrees to 119 degrees, 110 degrees to 119 degrees and/or in between, outside or overlapping these ranges. In some embodiments, the angles T1-T3 may be in range from about 10 degrees to 110 degrees, 20 degrees to 98 degrees, 50 degrees to 100 degrees, 65 degrees to 120 degrees, 80 degrees to 270 degrees, 85 degrees to 355 degrees and/or in between, outside or overlapping these ranges. The angles T1-T3 may the identical or at least one of the angles T1-T3 may be different from the rest.

In some embodiments, a sum of the angles T1-T3 (i.e., T1+T2+T3) may be in the range of about 250 degrees to 320 degrees, 220 degrees to 350 degrees, 270 degrees to 340 degrees, 300 degrees to 350 degrees, 290 degrees to 355 degrees, 330 degrees to 350 degrees and/or in between, outside or overlapping these ranges. In some embodiments, the sum of the angles T1-T3 (and the angles themselves) are structured such that, when the plurality of body structures 310(i)-310(iii) are assembled, a perpendicular distance between a free edge 311b(i) of a first structure 310(i) and an adjacent free edge 311a(iii) of a last structure 310(iii), is lesser than a maximum diameter of the pipes (22, 24) and/or a maximum diameter of the coupling member 26. Moreover, the perpendicular distance between the edges 311b(i) and 311a(iii) is such that assembly of the plurality of body structures 310(i)-310(iii) does not overlap the locking mechanism 28 and the coupling member 26 (as shown the FIG. 4c). FIG. 4b illustrates the pipe joint insulation component 300 described above and the pipe joint 2. The pipe joint 2 may also define an axis Y-Y.

As illustrated by FIG. 4a, each of the plurality of body structures 310(i)-310(iii) may further comprise one or more securing members 340(i)-340(iii) provided at their respective inner surfaces 304(i)-304(iii). The securing members 340(i)-340(iii) are structured for securing/coupling the respective body structure with an adjacent portion of the pipe joint 2, and the coupling member 26 in particular, upon assembly. In some embodiments, the securing members 340(i)-340(iii) comprise a clip type structure that allows for the respective body structure 310(i)-310(iii) to be snapped onto the coupling member 26.

For assembly with the pipe joint 2, the first body structure 310(i) may be placed over the coupling member 26 and coupled thereto via the respective securing members 340(i). Next, a second body structure 310(ii) is placed over the coupling member 26 and adjacent to the prior body structure, i.e., the first body structure 310(i). Furthermore, the second body structure 310(ii) is (a) coupled with the coupling member 26, and (b) coupled with the prior body structure, i.e., the first body structure 310(i). Here, for (a), the securing members 340(ii) of the second body structure 310(ii) are snapped onto the coupling member 26 and for (b), the first edge 311a(i) of the first body structure 310(i) is coupled with the second edge 311b(ii) of the second body structure 310(ii). Upon assembling the first body structure 310(i) and the second body structure 310(ii), in some embodiments, their respective arc centers O1 and O2 may (i) coincide with each other and/or (ii) coincide with the axis Y-Y of the pipe joint 2. Subsequent body structures are assembled in a similar manner.

A n^{th} or last body structure, i.e., a third body structure 310(iii) in this instance, is then is placed over the coupling member 26 and adjacent to the prior body structure, i.e., the second body structure 310(ii). Furthermore, the third body structure 310(iii) is (a) coupled with the coupling member 26, and (b) coupled with the prior body structure, i.e., the second body structure 310(ii). Here, for (a), the securing members 340(iii) of the third body structure 310(iii) are snapped onto the coupling member 26 and for (b), the first edge 311a(ii) of the second body structure 310(ii) is coupled with the second edge 311b(iii) of the third body structure 310(iii). Upon assembling the third body structure 310(iii), in some embodiments, the arc center O3 may (i) coincide preceding with arc centers O1-O2 and/or (ii) coincide with the axis Y-Y of the pipe joint 2. In this manner, the assembly shown in FIG. 4c is obtained.

As noted previously, a perpendicular distance between the edge 311b(i) of the first structure 310(i) and the adjacent edge 311a(iii) of the last (e.g., third) structure 310(iii), is lesser than a maximum diameter of the pipes (22, 24) and/or a maximum diameter of the coupling member 26. Moreover, the perpendicular distance between the edges 311b(i) and 311a(iii) is such that assembly of the plurality of body structures 310(i)-310(iii) does not overlap the locking mechanism 28 and the coupling member 26, as shown the FIG. 4c.

Here, the plurality of body structures 310(i)-310(iii) are structured for allowing assembly with the assembled pipe joint without requiring disassembly of the pipe joint. That said, it is also envisaged that the plurality of body structures 310(i)-310(iii) may be assembled together first and then subsequently assembled with pipe joint 2, in a manner similar to the one described with respect to the pipe joint insulation component 200, previously.

Moreover, similar to the pipe joint insulation component 200, the pipe joint insulation component 300 may further comprise one or more securing members (not illustrated) similar to the securing members 250, described previously.

The features of a hanger pipe insulation component of the present invention will now be described with respect to FIGS. 5-7. The hanger pipe insulation component is structured for insulating pipes having the hanger clamps. FIG. 5 illustrates a perspective view 50 of a pipe 1 having a hanger clamp 4, in accordance with one embodiment of the invention. As discussed previously, in exhaust systems, hanger clamps 4 are provided for attaching the pipe 1 to the frame (e.g., a frame of the exhaust system). The hanger clamp 4 comprises a pipe clamp element 42 structured for coupling the hanger clamp 4 with the pipe 1, and a hanger connection element 46 structured for coupling with the frame, as illustrated by FIG. 5. Only portions 1a and 1b of the pipe 1 are insulated and portion 1c of the pipe 1 is not insulated, as shown, because in conventional systems, the pipes having the hanger clamps 4 are left uninsulated along portions/regions 1c adjacent to the hanger clamps 4, (i) in order to accommodate the hanger clamps 4, and (ii) to allow for movement of the hanger clamps 4 along and over the pipe 1, e.g., during assembly to mitigate and compensate for production variations. Depending on the type of application, the length of the uninsulated pipe portion(s) 1c, adjacent the hanger clamp 4, may be up to 6 inches or more than 6 inches. However, it is desirable to provide insulation in the portions 1c.

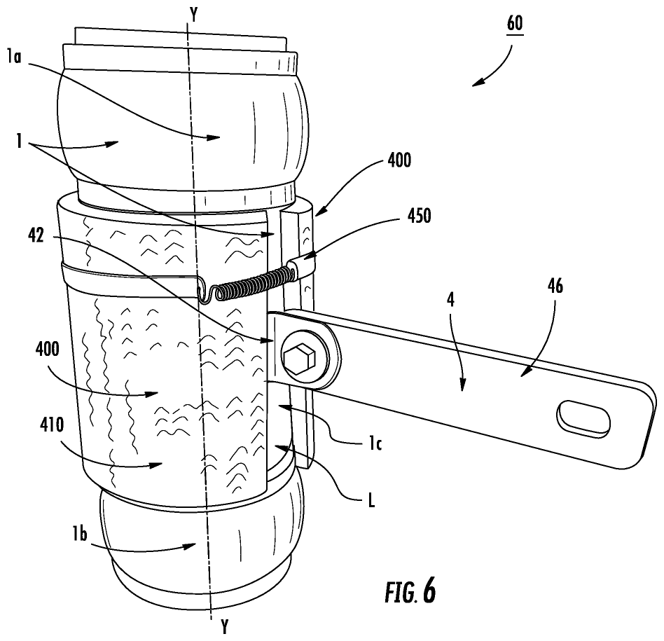

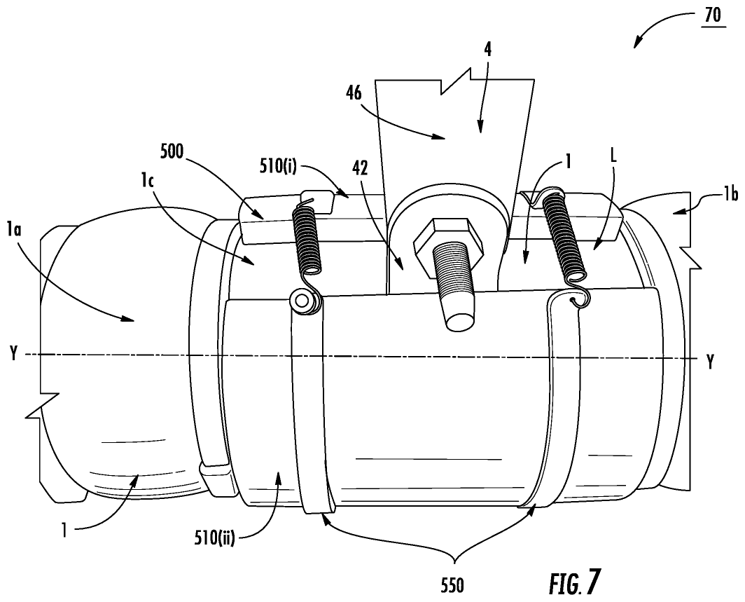

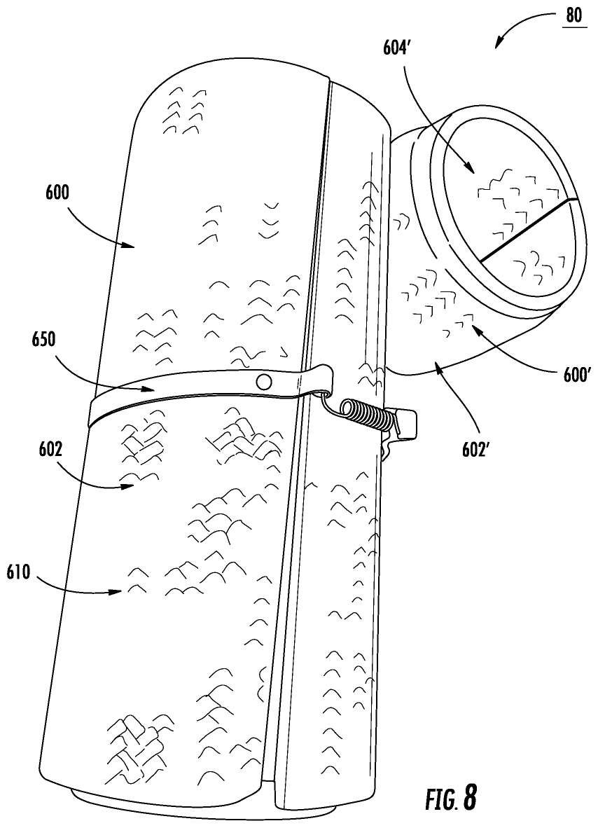

The hanger pipe insulation component (400, 500) of the present invention, illustrated by FIGS. 6-7, addresses the above challenges and alleviates the foregoing deficiencies, by providing comprehensive and customized insulation pipes having the hanger clamps, without impeding their movement of the hanger clamp 4 in the pipe portion 1c and without requiring disassembly of the hanger clamp 4. FIG. 6 is a perspective view 60 illustrating a hanger pipe insulation component 400, in accordance with one embodiment of the invention. The hanger pipe insulation component 400 comprises an insulation body 410. Typically, the insulation body 410 is flexible and capable of being bent, folded, elastically deformed, stretched and/or otherwise physically modified to at least partially conform to the shape of the underlying pipe 1. Here, in its unassembled state, the insulation body 410 may be a planar body, having a rectangular/square shape, or other polygonal or curvilinear shapes. For assembly, the insulation body 410 may be placed around the pipe portion 1c such that the insulation body 410 is curved (e.g., into a generally cylindrical shape) and at least partially conforms to the cylindrical shape of the underlying pipe portion 1c. That said, in some embodiments, the insulation body 410 may be a rigid structure that is molded/cured to conform to the shape of the underlying pipe 1.

In some embodiments, the thickness of the insulation body 410 is constant, while in other embodiments the thickness may be variable. Moreover, typically, the insulation body 410's length (circumferential, perpendicular to the axis Y-Y of the pipe) and height (axial, parallel to the axis Y-Y) are dimensioned such that the insulation body 410, upon assembly, substantially covers the pipe portion 1c, as illustrated. As illustrated by FIG. 6, the insulation body 410 substantially covers and insulates the pipe clamp element 42, forming a channel “L” between its ends. The hanger connection element 46 is positioned with this channel “L”, thereby (i) allowing for the hanger connection element 46 to be coupled with the frame, (ii) without impeding the linear motion of the pipe clamp element 42 underneath the insulation body 410, and without impeding the corresponding linear motion of the hanger connection element 46 in the channel L, in a direction parallel to the axis Y-Y.

In some embodiments, the insulation body 410 may aid in increasing, decreasing or otherwise regulating the temperature of the fluid within the pipe 1 and specifically the pipe portion 1c, so that the fluid is emitted at a desired temperature. In some embodiments, the insulation body 410 is made of one or more layers of composite materials, resins, polymers, fabrics, textiles, foam, and/or the like. These composite materials, resins, polymers, fabrics, etc. may be woven, knitted, braided, interlaced, non-woven, etc., as shown in FIGS. 6-7. In some embodiments, the one or more layers of the insulation body 410 may comprise structural fibers, resin fibers and/or elastic fibers, wherein: structural fibers comprise glass, carbon, polymer, ceramic, metallic, mineral and/or natural fibers; and resin fibers comprise polyethylene terephthalate (PET), polyamide (PA), polyphenylene sulfide (PPS), polyphenylene oxide ether (PPE), polyethylenimine (PEI), polyether ether ketone (PEEK), fluoric polymers such as polytetrafluoroethylene (PTFE), ethylene-tetrafluoroethylene (ETFE), polyvinylidenefluoride (PVDF), and/or ethylene-tetrafluoroethylene (ETFE) based fibers (which may be woven, knitted, braided, interlaced, etc.). In some embodiments, the one or more layers of the insulation body 410 may also comprise one or more liquid polymer matrix solutions configured to be applied to the one or more layers (e.g., after assembly of the hanger pipe insulation component 400 with the pipe 1 having a hanger clamp 4), and then optionally cured (e.g., thermally cured at a predetermined temperature). In some embodiments, the one or more liquid polymer matrix solutions comprise a dispersion of ground thermoplastic polymer in an organic or non-organic solvent.

As illustrated by FIG. 6, the hanger pipe insulation component 400 may further comprise one or more securing members 450, which may be looped over the insulation body 410 and tightened/secured to hold the insulation body 410 in place around the pipe 1. The securing member 450 may be any device, tool, or fastener configured to hold or secure the insulation body 410—pipe 1 assembly together, either by mechanical, magnetic, and/or chemical means. In some embodiments the securing member 450 is a spring-loaded band, which is configured to hold, secure, fasten, or lock the insulation body 410—pipe 1 assembly together, either removably or permanently. In some embodiments, the securing member 450 is a band clamp, which may comprise an elongate body and a clamp member at one end of the elongate body which is configured to secure the ends of the elongate body together, at a desired tension, such that the elongate member forms a loop. As such, the clamp member may comprise hose clamps, V-Clamps, buckles, locking ties, loops, screw clips, worm drive clips, center punch clamps, spring clamps, wire clamps, ear clamps, strapping seals, cable ties, marman clamps, clasps, band clips, a combination of portions of the preceding non-limiting examples, or any other suitable clamping devices known in the art. In some embodiments, the securing member 450 is configured to secure the insulation body 410 around the pipe 1 together, such that a desired compression (for example, radial and circumferential compression forces) may be applied onto the insulation body 410 and/or the pipe portion 1c by changing the circumference/dimensions of the loop formed. The securing member 450 may be made from any suitable material, such as but not limited to, metals, alloys, composites, plastics, etc. In this manner, the pipe portions having the hanger clamp may be insulted without requiring disassembly of the hanger clamp and without impeding its functional requirements.

FIG. 7 is a perspective view 70 illustrating yet another a hanger pipe insulation component 500, in accordance with another embodiment of the invention. The hanger pipe insulation component 500 comprises a plurality of insulation bodies 510(i)-510(ii). Typically, the insulation bodies 510(i)-510(ii) are flexible and capable of being bent, folded, elastically deformed, stretched and/or otherwise physically modified to at least partially conform to the shape of the underlying pipe 1. Here, in its unassembled state, each of the insulation bodies 510(i)-510(ii) may be a planar body, having a rectangular/square shape, or other polygonal or curvilinear shapes. For assembly, the insulation bodies 510(i)-510(ii) may be placed around the pipe portion 1c such that the insulation bodies 510(i)-510(ii) are curved (e.g., into a generally cylindrical shape) and at least partially conform to the cylindrical shape of the underlying pipe portion 1c. That said, in some embodiments, the insulation bodies 510(i)-510(ii) may be a rigid structure that is molded/cured to conform to the shape of the underlying pipe 1.

In some embodiments, the thickness of the each of the insulation bodies 510(i)-510(ii) is constant, while in other embodiments the thickness may be variable. Moreover, typically, the insulation bodies' 510(i)-510(ii) length (circumferential, perpendicular to the axis Y-Y of the pipe) and height (axial, parallel to the axis Y-Y) are dimensioned such that the insulation body 510(i)-510(ii), upon assembly, the insulation bodies 510(i)-510(ii), together, substantially cover the pipe portion 1c, as illustrated. For assembly adjacent ends of the insulation bodies together 510(i)-510(ii) are coupled together (not illustrated), while the opposite free ends form a channel L therebetween (in a similar manner as described with respect to the joint insulation component 300, previously). As illustrated by FIG. 7, the insulation bodies 510(i)-510(ii) together 510(i)-510(ii) substantially cover and insulate the pipe clamp element 42, forming a channel “L” between free ends of the insulation bodies 510(i)-510(ii). The hanger connection element 46 is positioned with this channel “L”, thereby (i) allowing for the hanger connection element 46 to be coupled with the frame, (ii) without impeding the linear motion of the pipe clamp element 42 underneath the insulation bodies 510(i)-510(ii), and without impeding the corresponding linear motion of the hanger connection element 46 in the channel L, in a direction parallel to the axis Y-Y.

In some embodiments, the insulation bodies 510(i)-510(ii) may aid in increasing, decreasing or otherwise regulating the temperature of the fluid within the pipe 1 and specifically the pipe portion 1c, so that the fluid is emitted at a desired temperature. In some embodiments, the insulation bodies 510(i)-510(ii) are made of one or more layers of composite materials, resins, polymers, fabrics, textiles, foam, and/or the like. These composite materials, resins, polymers, fabrics, etc. may be woven, knitted, braided, interlaced, non-woven, etc. In some embodiments, the one or more layers of the insulation bodies 510(i)-510(ii) may comprise structural fibers, resin fibers and/or elastic fibers, wherein: structural fibers comprise glass, carbon, polymer, ceramic, metallic, mineral and/or natural fibers; and resin fibers comprise polyethylene terephthalate (PET), polyamide (PA), polyphenylene sulfide (PPS), polyphenylene oxide ether (PPE), polyethylenimine (PEI), polyether ether ketone (PEEK), fluoric polymers such as polytetrafluoroethylene (PTFE), ethylene-tetrafluoroethylene (ETFE), polyvinylidenefluoride (PVDF), and/or ethylene-tetrafluoroethylene (ETFE) based fibers (which may be woven, knitted, braided, interlaced, etc.). In some embodiments, the one or more layers of the insulation bodies 510(i)-510(ii) may also comprise one or more liquid polymer matrix solutions configured to be applied to the one or more layers (e.g., after assembly of the hanger pipe insulation component 500 with the pipe 1 having a hanger clamp 4), and then optionally cured (e.g., thermally cured at a predetermined temperature). In some embodiments, the one or more liquid polymer matrix solutions comprise a dispersion of ground thermoplastic polymer in an organic or non-organic solvent.

As illustrated by FIG. 7, the hanger pipe insulation component 500 may further comprise one or more securing members 550, which may be looped over the insulation body 510(i)-510(ii) and tightened/secured to hold the insulation bodies 510(i)-510(ii) in place around the pipe 1. The securing member 550 may be any device, tool, or fastener configured to hold or secure the insulation bodies 510(i)-510(ii) and the pipe 1 together, either by mechanical, magnetic, and/or chemical means. In some embodiments the securing member 550 is a spring-loaded band, which is configured to hold, secure, fasten, or lock the insulation bodies 510(i)-510(ii) and pipe 1 together, either removably or permanently. In some embodiments, the securing member 550 is a band clamp, which may comprise an elongate body and a clamp member at one end of the elongate body which is configured to secure the ends of the elongate body together, at a desired tension, such that the elongate member forms a loop. As such, the clamp member may comprise hose clamps, V-Clamps, buckles, locking ties, loops, screw clips, worm drive clips, center punch clamps, spring clamps, wire clamps, ear clamps, strapping seals, cable ties, marman clamps, clasps, band clips, a combination of portions of the preceding non-limiting examples, or any other suitable clamping devices known in the art. In some embodiments, the securing member 550 is configured to (a) secure the insulation bodies 510(i)-510(ii) together and (b) secure the insulation bodies 510(i)-510(ii) around the pipe 1, such that a desired compression (for example, radial and circumferential compression forces) may be applied onto the insulation bodies 510(i)-510(ii) and/or the pipe portion 1c by changing the circumference/dimensions of the loop formed. The securing member 550 may be made from any suitable material, such as but not limited to, metals, alloys, composites, plastics, etc. In this manner, the pipe portions having the hanger clamp may be insulted without requiring disassembly of the hanger clamp and without impeding its functional requirements.

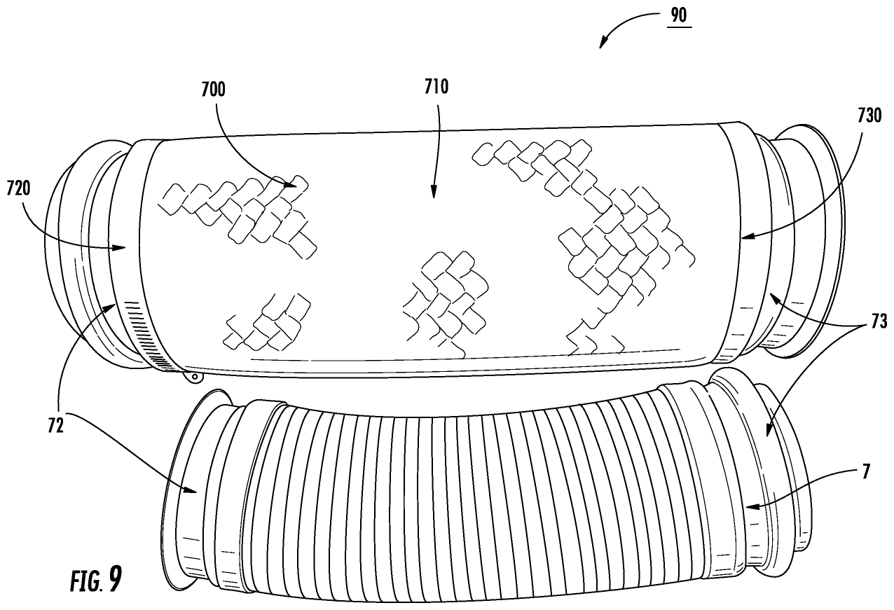

FIG. 8 is a perspective view 80 illustrating a preformed pipe insulation component, in accordance with one embodiment of the invention. In some embodiments, the insulation 600 (which may be substantially similar to the insulations described with respect to the joint insulation components 200-300, and/or hanger pipe insulation components 400-500) may be performed. These preformed insulations 600 may be manufactured are shipped to be installed/assembled with the exhaust system in-situ, without requiring thermal or chemical processing for the installation/assembly with the exhaust system. The preformed insulation 600 may be utilized to insulate any suitable pipe of the exhaust system. As illustrated, the preformed insulation 600 may comprise an insulation body 610 having an outer surface 602 and an opposite inner surface (illustrated at inner surface 604′ of the preformed insulation 600′ opposite its outer surface 602′). The preformed insulation 600 may comprise a substantially cylindrical structure.

In some embodiments, the insulation body 610 may aid in increasing, decreasing or otherwise regulating the temperature of the fluid within the pipe 1, so that the fluid is emitted at a desired temperature. In some embodiments, the insulation body 610 is made of one or more layers of composite materials, resins, polymers, fabrics, textiles, foam, and/or the like. These composite materials, resins, polymers, fabrics, etc. may be woven, knitted, braided, interlaced, non-woven, etc. In some embodiments, the one or more layers of the insulation body 610 may comprise structural fibers, resin fibers and/or elastic fibers, wherein: structural fibers comprise glass, carbon, polymer, ceramic, metallic, mineral and/or natural fibers; and resin fibers comprise polyethylene terephthalate (PET), polyamide (PA), polyphenylene sulfide (PPS), polyphenylene oxide ether (PPE), polyethylenimine (PEI), polyether ether ketone (PEEK), fluoric polymers such as polytetrafluoroethylene (PTFE), ethylene-tetrafluoroethylene (ETFE), polyvinylidenefluoride (PVDF), and/or ethylene-tetrafluoroethylene (ETFE) based fibers (which may be woven, knitted, braided, interlaced, etc.). In some embodiments, the one or more layers of the insulation body 610 may also comprise one or more liquid polymer matrix solutions configured to be applied to the one or more layers (e.g., after assembly of the hanger pipe insulation component 600 with a pipe), and then optionally cured (e.g., thermally cured at a predetermined temperature). In some embodiments, the one or more liquid polymer matrix solutions comprise a dispersion of ground thermoplastic polymer in an organic or non-organic solvent.

As illustrated by FIG. 8, the hanger pipe insulation component 600 may further comprise one or more securing members 650, which may be looped over the insulation body 610 and tightened/secured to hold the insulation body 610 in place around the pipe 1. The securing member 650 may be any device, tool, or fastener configured to hold or secure the insulation body 610—pipe assembly together, either by mechanical, magnetic, and/or chemical means. In some embodiments the securing member 650 is a spring-loaded band, which is configured to hold, secure, fasten, or lock the insulation body 610—pipe assembly together, either removably or permanently. In some embodiments, the securing member 650 is a band clamp, which may comprise an elongate body and a clamp member at one end of the elongate body which is configured to secure the ends of the elongate body together, at a desired tension, such that the elongate member forms a loop. As such, the clamp member may comprise hose clamps, V-Clamps, buckles, locking ties, loops, screw clips, worm drive clips, center punch clamps, spring clamps, wire clamps, ear clamps, strapping seals, cable ties, marman clamps, clasps, band clips, a combination of portions of the preceding non-limiting examples, or any other suitable clamping devices known in the art. In some embodiments, the securing member 650 is configured to secure the insulation body 610 around the pipe together, such that a desired compression (for example, radial and circumferential compression forces) may be applied onto the insulation body 610 and/or the pipe by changing the circumference/dimensions of the loop formed. The securing member 650 may be made from any suitable material, such as but not limited to, metals, alloys, composites, plastics, etc. In this manner, the pipe portions having the hanger clamp may be insulted without requiring disassembly of the hanger clamp and without impeding its functional requirements.

FIGS. 9-10 illustrate perspective views of a bellows insulation component 700 structured for insulating one or more bellows 7 of the exhaust system, in accordance with one embodiment of the invention. As discussed previously, the one or more bellows 7 may comprise flexible pipes structured for isolating and absorbing vibrations from an associated engine exhaust system. Moreover, the one or more bellows 7 are typically required to be flexible for the purposes of mitigating vibration from the engine. The bellows insulation component 700 of the present invention is flexible and structured for insulating the one or more bellows 7 without rendering them inflexible. The bellows insulation component 700 comprises an insulation body 710 (similar to the insulations described with respect to the joint insulation components 200-300, hanger pipe insulation components 400-500, and/or the preformed insulation 600). The insulation body 710 comprises a substantially cylindrical shape with a first end 720 and an opposite second end 730. For assembly, the first end 720 is coupled with a first end 72 of the bellows and the second end 730 is coupled with a second end 73 of the bellows.

While the present invention has been disclosed with reference to certain embodiments, numerous modifications, alterations and changes to the described embodiments and other new embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the sphere and scope of the appended claims. Although specific terms are employed herein, they are used in a generic and descriptive sense only and not for purposes of limitation. Accordingly, it is intended that the present invention not be limited to the described embodiments, but that it has the full scope defined by the language of the following claims, and equivalents thereof. In addition, where possible, any terms expressed in the singular form herein are meant to also include the plural form and/or vice versa. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Furthermore, references to “one embodiment” of the present invention are not intended to be interpreted as excluding the existence of additional embodiments that also incorporate the recited features. The following claims are in no way intended to limit the scope of the disclosure to the specific embodiments described herein. While the foregoing is directed to embodiments of a corrugated band clamp, and components thereof, other and further embodiments may be devised without departing from the basic scope thereof, and the scope thereof is determined by the claims that follow.

What is claimed is:

1. A pipe joint insulation component, comprising:
a first body structure comprising an insulation body portion, wherein the insulation body portion is structured for insulating a pipe joint of an exhaust system, wherein the first body structure comprises a cavity structured for receiving the pipe joint therethrough; and
wherein the insulation body portion comprises one or more insulation layers.

2. The pipe joint insulation component of claim 1, wherein the first body structure comprises a cutout void; wherein the cutout void comprises a first width lesser than a diameter of the pipe joint.

3. The pipe joint insulation component of claim 2, wherein the cutout void is structured to receive a pipe joint therethrough in a radial direction substantially perpendicular to an axis of the first body structure.

4. The pipe joint insulation component of claim 1, wherein the pipe joint insulation component comprises one or more securing members structured for securing the first body structure around the pipe joint.

5. The pipe joint insulation component of claim 4, wherein the one or more securing members comprise a band clamp and/or a spring-loaded clamp.

6. The pipe joint insulation component of claim 1, wherein the first body structure is structured to be coupled with a coupling member of the pipe joint.

7. The pipe joint insulation component of claim 1, wherein the first body structure comprises one or more securing members at an inner surface.

8. The pipe joint insulation component of claim 7, wherein the one or more securing members are structured to couple the first body structure with a coupling member of the pipe joint.

9. The pipe joint insulation component of claim 1, further comprising a second body structure, wherein the second body structure is configured to be coupled with the first body structure.

10. A hanger pipe insulation component, comprising:
a first insulation body portion structured for at least partially enclosing and insulating an exhaust system pipe at a portion of the pipe proximate a hanger pipe assembled onto the pipe; and
wherein the first insulation body comprises one or more insulation layers.

11. The hanger pipe insulation component of claim 10, wherein the first insulation body portion is structured to enclose the pipe such that linear motion of the hanger pipe in a direction substantially parallel to an axis of the pipe is not blocked.

12. The hanger pipe insulation component of claim 10, wherein the first insulation body portion is flexible.

13. The hanger pipe insulation component of claim 10, wherein the hanger pipe insulation component comprises one or more securing members structured for securing the first body structure around the pipe joint.

14. The hanger pipe insulation component of claim 13, wherein the one or more securing members comprise a band clamp and/or a spring-loaded clamp.

15. The hanger pipe insulation component of claim 10, wherein the one or more insulation layers comprises a knitted layer and/or a woven layer.

16. The hanger pipe insulation component of claim 10, further comprising a second insulation body portion, wherein the insulation body portion is configured to be coupled with the first insulation body portion.

17. A bellows insulation component, comprising:
an insulation body portion structured for insulating one or more bellows of an exhaust system, wherein the insulation body is structured for at least partially enclosing and insulating the one or more bellows; and
wherein the insulation body comprises one or more insulation layers.

18. The bellows insulation component of claim 17, wherein the insulation body portion comprises a cavity structured to receive the one or more bellows therethrough, wherein the insulation body is structured insulating the one or more bellows without blocking flexibility of the one or more bellows.

19. The bellows insulation component of claim 17, wherein the insulation body portion is flexible.

20. The bellows insulation component of claim 17, wherein the ends of the insulation body portion are secured to adjacent ends of the one or more bellows.

21. The bellows insulation component of claim 17, wherein the one or more insulation layers comprises a knitted layer and/or a woven layer.

22. An exhaust insulation system, comprising:
a pipe joint insulation component structured for insulating a pipe joint of an exhaust system;
a hanger pipe insulation component structured for insulating an exhaust system pipe at a portion of the pipe proximate a hanger pipe assembled onto the pipe; and/or
a bellows insulation component structured for insulating one or more bellows of the exhaust system.
